(19) United States
(12) Patent Application Publication
(10) Pub. No.: US 2025/0329956 A1
(43) Pub. Date: Oct. 23, 2025

(54) Connector with Holder

(71) Applicant: Yazaki Corporation, Tokyo (JP)

(72) Inventors: Yosuke Akagi, Shizuoka (JP); Kaoru Matsumura, Shizuoka (JP)

(21) Appl. No.: 19/075,407

(22) Filed: Mar. 10, 2025

(30) Foreign Application Priority Data
Apr. 19, 2024 (JP) 2024-067869

(51) Int. Cl. H01R 13/436

(52) U.S. Cl. CPC H01R 13/4365

(57) ABSTRACT

A connector with a holder, the connector includes a bottomed tubular housing that includes a holder accommodating portion and that is provided with a terminal, and a holder that is inserted into the holder accommodating portion and that includes a base portion formed with a hole through which the terminal is inserted. The holder includes a rib body portion that protrudes from the base portion, and a rib reinforcing portion that protrudes from an upper face of the rib body portion. An insertion hole is formed at a position of the rib body portion that is adjacent to the rib reinforcing portion or at a position of the rib reinforcing portion that is adjacent to the rib body portion. A hook portion provided at a distal end portion of a jig is inserted into the insertion hole when the holder is removed from the housing.

### CROSS-REFERENCE TO RELATED APPLICATIONS

This application is based on and claims priority under 35 USC 119 from Japanese Patent Application No. 2024-067869 filed on Apr. 19, 2024, the entire content of which is incorporated herein by reference.

### TECHNICAL FIELD

The present disclosure relates to a connector with a holder.

### BACKGROUND ART

As shown in FIG. 6, a connector 23 with a holder described in JP H09-45411A includes a bottomed tubular housing 24 including a partition wall portion 24a, and a front holder 26 that is accommodated in a holder accommodating portion 25 provided in the partition wall portion 24a. A through hole 25a through which a male terminal 27 is inserted is formed in the partition wall portion 24a at a position above the holder accommodating portion 25, and a tab 27a of the male terminal 27 protrudes into the holder accommodating portion 25 through the through hole 25a. In the arrangement shown in FIG. 6, the front holder 26 is completely inserted into the holder accommodating portion 25 of the housing 24 and then locked to the partition wall portion 24a to be in a fully locked state. As shown in FIGS. 6 and 7, a hook-shaped portion 28 that protrudes from one end portion 26a of the front holder 26 in the thickness direction is formed on the one end portion 26a.

At the time of the shipping operation, for example, the front holder 26 is brought from the fully locked state shown in FIG. 6 to a temporarily locked state in which the front holder 26 is pulled out a predetermined distance from the holder accommodating portion 25 of the housing 24. When the front holder 26 is pulled out from the fully locked state to the temporarily locked state, the front holder 26 is pulled out along a direction Q away from an end portion 25a of the holder accommodating portion 25 in a state in which the hook portion of the removal jig including the hook portion at the distal end portion thereof is hooked onto the hook-shaped portion 28 of the front holder 26.

In JP H09-45411A, when the operator brings the hook portion of the removal jig close to the hook-shaped portion 28 of the front holder 26 to hook the hook portion onto the hook-shaped portion 28 during the release from the fully locked state to the temporarily locked state of the front holder 26, the removal jig comes into contact with the tab 27a of the male terminal 27 that is located above the front holder 26, and thus the tab 27a may be damaged.

The present disclosure provides a connector with a holder capable of preventing damage to a terminal when a holder is released from a fully locked state to a temporarily locked state.

### SUMMARY OF INVENTION

A connector with a holder, the connector includes a bottomed tubular housing that includes a holder accommodating portion and that is provided with a terminal protruding into the holder accommodating portion, and a holder that is inserted into the holder accommodating portion, that is lockable to a wall portion of the holder accommodating portion located on a side opposite to an opening end of the holder accommodating portion, and that includes a base portion formed with a hole through which the terminal is inserted. The holder includes a rib body portion that protrudes from the base portion toward the opening end of the holder accommodating portion, and a rib reinforcing portion that protrudes from an upper face of the rib body portion and that extends from the base portion to a distal end of the rib body portion. An insertion hole is formed at a position of the rib body portion that is adjacent to the rib reinforcing portion or at a position of the rib reinforcing portion that is adjacent to the rib body portion. A hook portion provided at a distal end portion of a jig is inserted into the insertion hole when the holder is removed from the housing.

According to the present disclosure, when the holder is released from the fully locked state to the temporarily locked state, the hook portion of the jig is guided to the insertion hole along the rib body portion or the rib reinforcing portion, and the jig and the terminal are less likely to come into contact with each other. Therefore, it is possible to prevent damage to the terminal.

### BRIEF DESCRIPTION OF DRAWINGS

FIG. 1 is an exploded perspective view of a connector with a holder according to an embodiment;

FIG. 2 is a perspective view showing the connector with a holder in a fully locked state;

FIG. 3 is an explanatory view showing a step of inserting a removal jig when the male front holder is released from the fully locked state to a temporarily locked state;

FIG. 4 is an explanatory view showing a step of hooking the removal jig when the male front holder is released from the fully locked state to the temporarily locked state;

FIG. 5 is an explanatory view showing a step of pulling out the removal jig when the male front holder is released from the fully locked state to the temporarily locked state;

FIG. 6 is a cross-sectional view of a connector with a holder in the related art; and

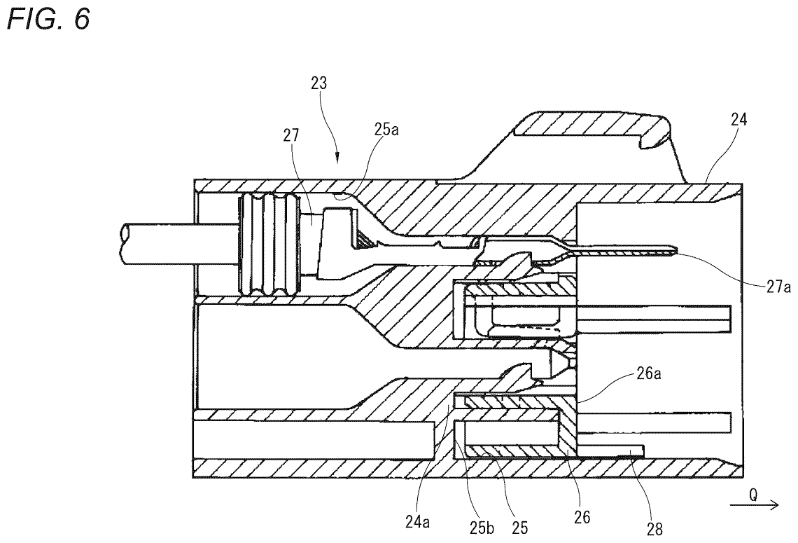

FIG. 7 is a perspective view of a holder in the related art.

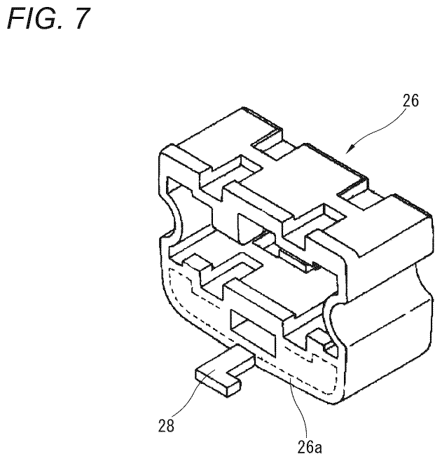

### DESCRIPTION OF EMBODIMENTS

Hereinafter, an embodiment of a connector with a holder according to the present disclosure will be described with reference to the drawings.

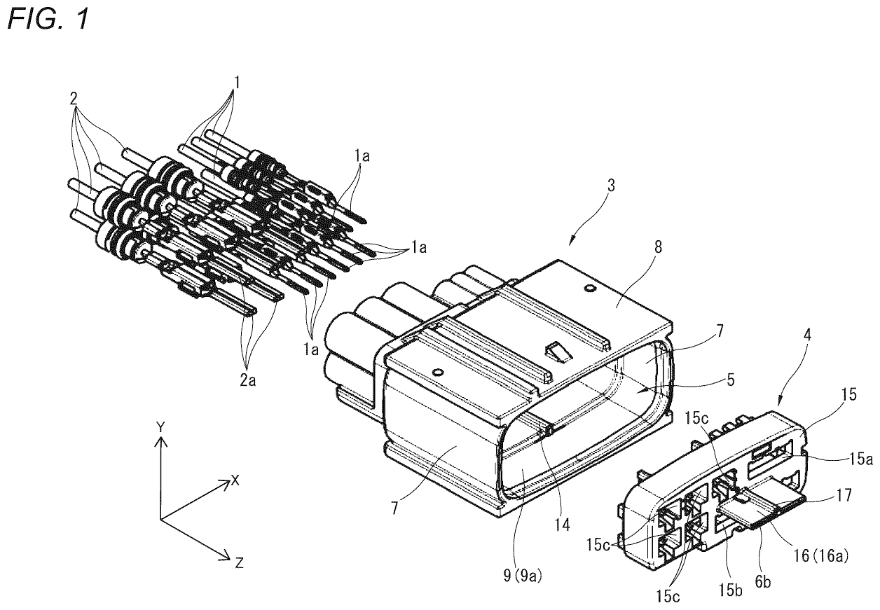

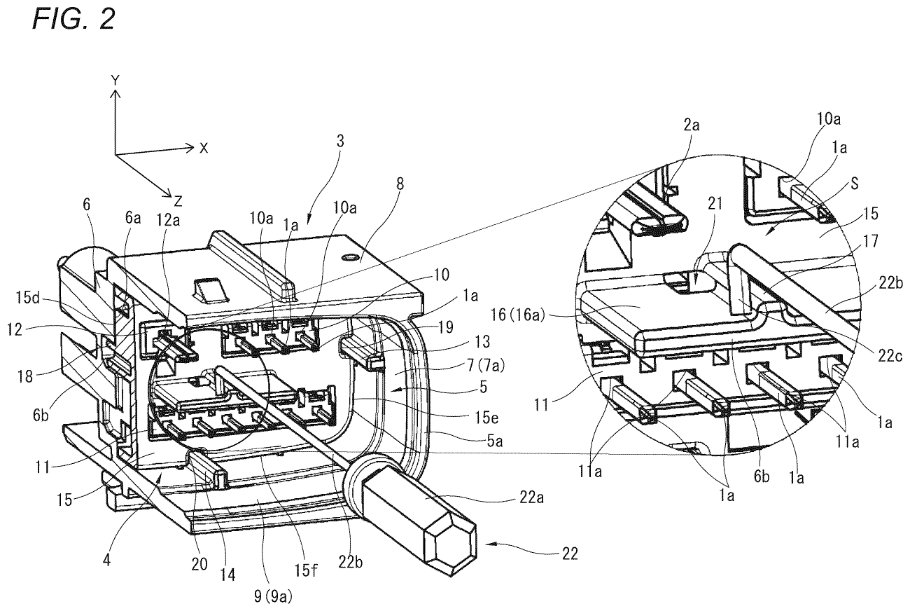

FIG. 1 is an exploded perspective view of a connector with a holder according to an embodiment. FIG. 2 is a perspective view showing the connector with a holder in a fully locked state. In FIG. 2, for convenience of description, a part of the perspective view is shown in cross section.

The connector with a holder includes a male housing (corresponding to a “housing” in the claims) 3 provided with a plurality of first male terminals (corresponding to “terminals” in the claims) 1 and a plurality of second male terminals (corresponding to “terminals” in the claims) 2, and a male front holder (corresponding to a “holder” in the claims) 4.

Here, for convenience of description, in FIGS. 1 and 2, the longitudinal direction of the male housing 3 is defined as a “longitudinal direction X”, a direction orthogonal to the longitudinal direction X and along the short side of the male housing 3 is defined as an “upper-lower direction Y”, and a direction orthogonal to the longitudinal direction X and the upper-lower direction Y is defined as a “pulling-out direction Z” of the male front holder 4.

As shown in FIG. 1, the plurality of (nine in the present embodiment) first male terminals 1 are arranged such that three first male terminals 1 are aligned along the longitudinal direction X in the upper stage located on the upper side in the upper-lower direction Y and six first male terminals 1 are aligned along the longitudinal direction X in the lower stage located on the lower side in the upper-lower direction Y. Each of the first male terminals 1 includes a first tab 1a that protrudes into the holder accommodating portion 5 provided in the male housing 3.

As shown in FIG. 1, the plurality of (five in the present embodiment) second male terminals 2 are larger than the first male terminals 1, and three second male terminals 2 are aligned along the longitudinal direction X in the upper stage and two second male terminals 2 are aligned along the longitudinal direction X in the lower stage. Each of the second male terminals 2 includes a second tab 2a that protrudes into the holder accommodating portion 5 provided in the male housing 3.

The male housing 3 is made of a synthetic resin material and has a bottomed rectangular tubular shape. The male housing 3 includes a base wall portion (corresponding to a “wall portion” in the claims 6, a pair of side wall portions 7, an upper wall portion 8, and a lower wall portion 9. The base wall portion 6 has a rectangular plate shape whose long side extends along the longitudinal direction X. The side wall portion 7 has a rectangular plate shape, and stands upright from both side edges of the base wall portion 6 along the pulling-out direction Z. The upper wall portion 8 has a rectangular plate shape, and stands upright from the upper edge of the base wall portion 6 along the pulling-out direction Z. The upper wall portion 8 is coupled to the upper end portions of the pair of side wall portions 7 in the upper-lower direction Y. The lower wall portion 9 has a rectangular shape similar to that of the upper wall portion 8, and stands upright from the lower edge of the base wall portion 6 along the pulling-out direction Z. A space surrounded by the base wall portion 6, the pair of side wall portions 7, the upper wall portion 8, and the lower wall portion 9 is the holder accommodating portion 5 that accommodates the male front holder 4. The holder accommodating portion 5 includes an opening end 5a at one end portion thereof in the pulling-out direction Z.

As shown in FIG. 2, a first protruding portion 10, a second protruding portion 11, and a third protruding portion 12 protrude from an inner surface 6a of the base wall portion 6.

The first protruding portion 10 has a rectangular parallelepiped shape, and protrudes from the inner surface 6a of the base wall portion 6 into the holder accommodating portion 5 along the pulling-out direction Z. The first protruding portions 10 are provided at the positions corresponding to the three first male terminals 1 that are located in the upper stage in the upper-lower direction Y. At the positions of the first protruding portions 10 corresponding to the three first male terminals 1, first tab through holes 10a penetrate the first protruding portions 10 along the pulling-out direction Z. The first tab 1a of the first male terminal 1 is inserted through the first tab through hole 10a, and the first tab 1a protrudes into the holder accommodating portion 5.

The second protruding portion 11 has a rectangular parallelepiped shape that has a larger length along the longitudinal direction X than the first protruding portion 10, and protrudes from the inner surface 6a of the base wall portion 6 into the holder accommodating portion 5 along the pulling-out direction Z. The second protruding portions 11 are provided at the positions corresponding to the six first male terminals 1 that are located in the lower stage in the upper-lower direction Y. At the positions of the second protruding portions 11 corresponding to the six first male terminals 1, second tab through holes 11a penetrate the second protruding portions 11 along the pulling-out direction Z. The first tab 1a of the first male terminal 1 is inserted through the second tab through hole 11a, and the first tab 1a protrudes into the holder accommodating portion 5. 5

The third protruding portion 12 has a rectangular parallelepiped shape, and protrudes from the inner surface 6a of the base wall portion 6 into the holder accommodating portion 5 along the pulling-out direction Z. The third protruding portions 12 are provided at the positions corresponding to the three second male terminals 2 that are located in the upper stage in the upper-lower direction Y and at the positions corresponding to the two second male terminals 2 that are located in the lower stage in the upper-lower direction Y. At the positions of the third protruding portions 12 corresponding to the five second male terminals 2, third tab through holes 12a penetrate the third protruding portions 12 along the pulling-out direction Z. The second tab 2a of the second male terminal 2 is inserted through the third tab through hole 12a, and the second tab 2a protrudes into the holder accommodating portion 5.

As shown in FIG. 2, a first guide protrusion 13 protrudes at a position on the inner surface 7a of the side wall portion 7 that is close to the upper wall portion 8. The first guide protrusion 13 guides the male front holder 4 when the male front holder 4 is inserted into the holder accommodating portion 5 or when the male front holder 4 is pulled out from the holder accommodating portion 5. The first guide protrusion 13 protrudes from the inner surface 7a of the side wall portion 7 toward the inside of the holder accommodating portion 5. The first guide protrusion 13 is continuous from the base wall portion 6 to the center position of the side wall portion 7 in the pulling-out direction Z.

As shown in FIGS. 1 and 2, a second guide protrusion 14 protrudes from an inner surface 9a of the lower wall portion 9. The second guide protrusion 14 guides the male front holder 4 when the male front holder 4 is inserted into the holder accommodating portion 5 or when the male front holder 4 is pulled out from the holder accommodating portion 5. The second guide protrusion 14 protrudes from the inner surface 9a of the lower wall portion 9 toward the inside of the holder accommodating portion 5. The second guide protrusion 14 is continuous from the base wall portion 6 to the center position of the lower wall portion 9 in the pulling-out direction Z.

The male front holder 4 is made of a synthetic resin material, and has a substantially rectangular plate shape. The male front holder 4 includes a base portion 15, a rib body portion 16, and a rib reinforcing portion 17.

The base portion 15 has a rectangular plate shape. At the position of the base portion 15 corresponding to the first protruding portion 10 of the male housing 3, a first protruding portion insertion hole 15a penetrates the base portion 15 along the pulling-out direction Z. The first protruding portion insertion hole 15a has a rectangular shape when viewed from a direction opposite to the pulling-out direction Z, and is slightly larger than the outer diameter of the first protruding portion 10. The first protruding portion 10 is inserted into the first protruding portion insertion hole 15a.

At the position of the base portion 15 corresponding to the second protruding portion 11 of the male housing 3, a second protruding portion insertion hole 15b penetrates the base portion 15 along the pulling-out direction Z. The second protruding portion insertion hole 15b has a rectangular shape when viewed from a direction opposite to the pulling-out direction Z, and is slightly larger than the outer diameter of the second protruding portion 11. The second protruding portion 11 is inserted into the second protruding portion insertion hole 15b.

At the positions of the base portion 15 corresponding to the third protruding portions 12 of the male housing 3, third protruding portion insertion holes 15c penetrate the base portion 15 along the pulling-out direction Z. The third protruding portion insertion hole 15c has a substantially rectangular shape when viewed from a direction opposite to the pulling-out direction Z, and is slightly larger than the outer diameter of the third protruding portion 12. The third protruding portion 12 is inserted into the third protruding portion insertion hole 15c.

As shown in FIG. 2, a ridge portion 18 protrudes from a surface 15d of the base portion 15 that faces the base wall portion 6 of the male housing 3. The ridge portion 18 protrudes from the center position of the surface 15d in the upper-lower direction Y to the side opposite to the pulling-out direction Z. In the fully locked state of the male front holder 4 shown in FIG. 2, the ridge portion 18 is locked by being fitted into a recess 6b formed in the base wall portion 6 of the male housing 3. In the fully locked state, the surface 15d of the base portion 15 of the male front holder 4 abuts against the inner surface 6a of the base wall portion 6 of the male housing 3.

A plurality of ridge portions are formed on the surface 15d of the base portion 15 in addition to the ridge portion 18, and a plurality of recesses that each are to be engaged with a respective one of the plurality of ridge portions described above are formed in the base wall portion 6 of the male housing 3. However, the description of the ridge portions and the recesses will be omitted.

A first recess 19 is formed in a portion of a side portion 15e of the base portion 15 that corresponds to the first guide protrusion 13 of the male housing 3. The first recess 19 is slightly larger than the outer diameter of the first guide protrusion 13. The first recess 19 slides against the outer side face of the first guide protrusion 13 when the male front holder 4 is inserted into the holder accommodating portion 5 or when the male front holder 4 is pulled out from the holder accommodating portion 5. By this sliding, the male front holder 4 can be stably inserted into and pulled out from the holder accommodating portion 5.

A second recess 20 is formed in a portion of a lower portion 15f of the base portion 15 that corresponds to the second guide protrusion 14 of the male housing 3. The second recess 20 is slightly larger than the outer diameter of the second guide protrusion 14. The second recess 20 slides against the outer side face of the second guide protrusion 14 when the male front holder 4 is inserted into the holder accommodating portion 5 or when the male front holder 4 is pulled out from the holder accommodating portion 5. By this sliding, the male front holder 4 can be stably inserted into and pulled out from the holder accommodating portion 5.

As shown in FIG. 2, the rib body portion 16 narrows a space S near the first male terminal 1 and the second male terminal 2 in the holder accommodating portion 5. By narrowing the space S in this way, when a finger of a hand of an operator enters the holder accommodating portion 5, the finger is prevented from coming into contact with the first tab 1a of the first male terminal 1 or the second tab 2a of the second male terminal 2. The rib body portion 16 has a rectangular plate shape, and protrudes from the base portion 15 toward the opening end 5a of the holder accommodating portion 5 along the pulling-out direction Z. As shown in FIG. 2, the length of the rib body portion 16 along the pulling-out direction Z is smaller than the lengths of the side wall portion 7, the upper wall portion 8, and the lower wall portion 9 along the pulling-out direction Z. As shown in FIG. 1, the length of the rib body portion 16 along the longitudinal direction X is smaller than the length of the second protruding portion insertion hole 15b along the longitudinal direction X.

The rib reinforcing portion 17 reinforces the rigidity of the rib body portion 16 that protrudes from the base portion 15 in the form of a cantilever beam. The rib reinforcing portion 17 protrudes upward from the center position of the upper face 16a of the rib body portion 16 in the longitudinal direction X. The rib reinforcing portion 17 extends from the base portion 15 to a distal end 16b of the rib body portion 16. The rib reinforcing portion 17 has a rectangular shape when viewed from a direction (an insertion direction T of a removal jig 22 to be described later) opposite to the pulling-out direction Z.

At a position of the rib body portion 16 that is adjacent to the rib reinforcing portion 17 and the base portion 15, a portion is present that is closest to the rib reinforcing portion 17, the base portion 15, and the rib body portion 16 and that has the highest rigidity, and an insertion hole 21 penetrates this portion along the upper-lower direction Y. In the present embodiment, the insertion hole 21 is formed at a position of the rib body portion 16 that is adjacent to the rib reinforcing portion 17 and the base portion 15 and on the side opposite to the first recess 19 with the rib reinforcing portion 17 interposed therebetween. The insertion hole 21 may be formed in the rib body portion 16 at a position on the side opposite to the position formed in the present embodiment with the rib reinforcing portion 17 interposed therebetween, instead of the position formed in the present embodiment. A hook portion 22c of the removal jig 22 to be described later is inserted into the insertion hole 21 when the male front holder 4 is released from the fully locked state to the temporarily locked state. The insertion hole 21 has a substantially rectangular shape when viewed from the upper-lower direction Y.

The insertion hole 21 does not necessarily need to be formed at a position of the rib body portion 16 that is adjacent to the rib reinforcing portion 17 and the base portion 15, but may be formed at any position of the rib body portion 16 that is adjacent to the rib reinforcing portion 17.

If the height of the rib reinforcing portion 17 in the upper-lower direction Y is larger

than the protruding height shown in FIGS. 1 and 2, the insertion hole 21 may be formed at a position of the rib reinforcing portion 17 that is adjacent to the rib body portion 16 instead of forming the insertion hole 21 in the rib body portion 16 as described above. In this case, it is desirable to form the insertion hole 21 at a position of the rib reinforcing portion 17 that is adjacent to the rib body portion 16 and the base portion 15.

A female housing including a plurality of female terminals (not shown) is fitted to the male housing 3 to which the male front holder 4 is attached. Then, the first male terminal 1 and the second male terminal 2 that are provided in the male housing 3 are electrically connected to the corresponding female terminals of the female housing.

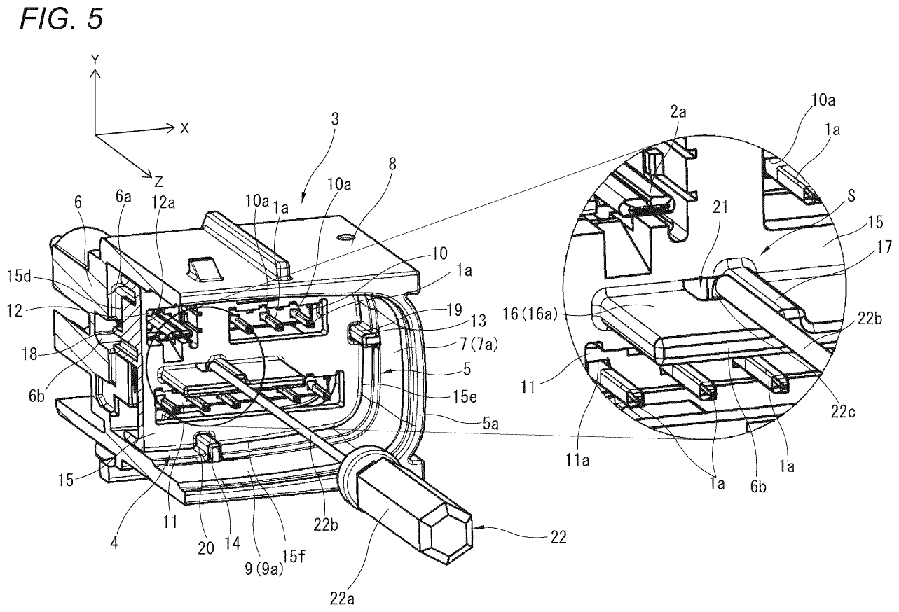

The removal jig 22 is a jig for an operator to perform a removal operation of the male front holder 4 when the male front holder 4 is released from the fully locked state shown in FIG. 2 to the temporarily locked state (see FIG. 5). The removal jig 22 includes a gripping portion 22a and a pulling-out portion 22b. The gripping portion 22a has a substantially hexagonal columnar shape, and is the portion that is gripped by an operator when the male front holder 4 is released. The pulling-out portion 22b includes a hook portion 22c that is formed by bending the distal end portion of an elongated columnar member made of metal into an L shape, and the male front holder 4 is pulled out along the pulling-out direction Z by hooking the hook portion 22c into the insertion hole 21 of the rib body portion 16. As shown in FIG. 2, the length of the hook portion 22c along the upper-lower direction Y is larger than the protruding height of the rib reinforcing portion 17 in the upper-lower direction Y.

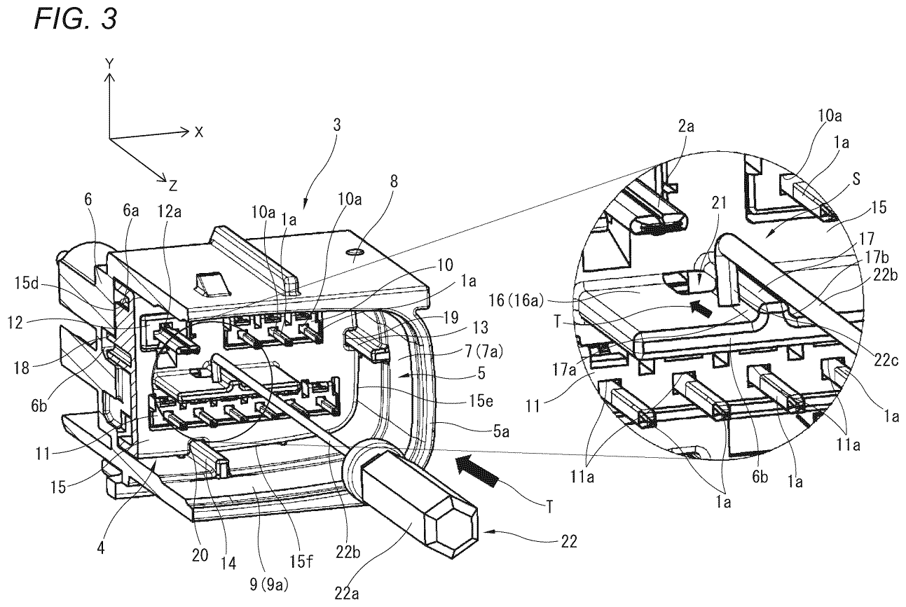

Next, a method for releasing the male front holder 4 from the fully locked state to the temporarily locked state will be described with reference to FIGS. 3 to 5. This releasing operation is performed when the connector with a holder is shipped or when the connector is repaired.

First, as shown in FIG. 3, an operator (not shown) inserts the removal jig 22 toward the insertion hole 21 along the insertion direction T of the removal jig 22. At the time of this insertion, the removal jig 22 is inserted along the insertion direction T while the portion of the outer peripheral portion of the hook portion 22c on the rib reinforcing portion 17 side is brought into contact with a side face 17a adjacent to the insertion hole 21 out of two side faces 17a and 17b of the rib reinforcing portion 17 in the longitudinal direction X.

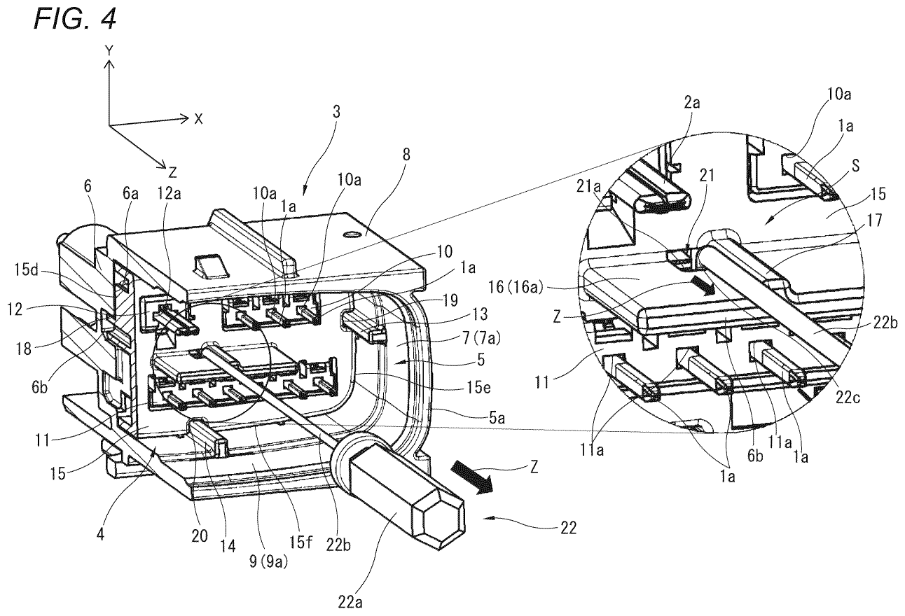

Then, the removal jig 22 is inserted along the insertion direction T until the hook portion 22c abuts against the base portion 15 of the male front holder 4, and then the removal jig 22 is moved downward in the upper-lower direction Y. By this movement, as shown in FIG. 4, the hook portion 22c is inserted into the insertion hole 21 of the rib body portion 16.

As shown in FIG. 4, after the hook portion 22c is inserted, the hook portion 22c is hooked onto an inner wall 21a of the insertion hole 21 by moving the removal jig 22 along the pulling-out direction Z.

Then, as shown in FIG. 5, the male front holder 4 is brought into the temporarily locked state by pulling out the removal jig 22 along the pulling-out direction Z. In this temporarily locked state, the ridge portion 18 of the male front holder 4 is located outside the recess 6b of the male housing 3, and the surface 15d of the base portion 15 of the male front holder 4 is separated from the inner surface 6a of the base wall portion 6 of the male housing 3.

When the insertion hole 21 is not formed in the rib body portion 16 but is formed at a position that is adjacent to the rib body portion 16 and the base portion 15 in the rib reinforcing portion 17, the hook portion 22c of the removal jig 22 is guided along the insertion direction T while being in contact with the upper face 16a of the rib body portion 16 in a posture in which the hook portion 22c is parallel to the rib body portion 16 and the end portion of the hook portion 22c faces the rib reinforcing portion 17, and then the hook portion 22c is inserted toward the insertion hole 21.

As described above, in the present embodiment, the male front holder 4 includes the rib body portion 16 that protrudes from the base portion 15 toward the opening end 5a of the holder accommodating portion 5, and the rib reinforcing portion 17 that protrudes from the rib body portion 16 and that extends from the base portion 15 to the distal end 16b of the rib body portion 16. The insertion hole 21 is formed in the rib body portion 16 at a position that is adjacent to the rib reinforcing portion 17. Therefore, when the male front holder 4 is released from the fully locked state to the temporarily locked state, an operator inserts the removal jig 22 along the insertion direction T while bringing the outer peripheral portion of the hook portion 22c of the removal jig 22 into contact with the side face 17a of the rib reinforcing portion 17, so that the removal jig 22 is stably guided toward the insertion hole 21. Therefore, since the pulling-out portion 22b and the hook portion 22c are less likely to come into contact with the first tab 1a of the first male terminal 1 and the second tab 2a of the second male terminal 2 that protrude into the holder accommodating portion 5, damage to the first tab 1a and the second tab 2a can be prevented.

In the present embodiment, the insertion hole 21 is formed at a position of the rib body portion 16 that is adjacent to the base portion 15, that is, at the root portion of the rib body portion 16. As described above, the insertion hole 21 is also at a position that is adjacent to the rib reinforcing portion 17, and is formed at a portion that is close to the base portion 15, the rib body portion 16, and the rib reinforcing portion 17 and that has the highest rigidity. When the male front holder 4 is released from the fully locked state to the temporarily locked state, it is necessary to pull out the removal jig 22 with a relatively strong force in a state in which the hook portion 22c is hooked onto the inner wall 21a of the insertion hole 21, and thus a large force also acts on the inner wall 21a of the insertion hole 21. Therefore, by forming the insertion hole 21 in the root portion having the highest rigidity of the rib body portion 16 as in the present embodiment, it is possible to prevent the rib body portion 16 from being damaged by the removal jig 22.

When the insertion hole 21 is at a position of the rib body portion 16 that is adjacent to the base portion 15, the hook portion 22c of the removal jig 22 can be easily inserted into the insertion hole 21 only by moving the hook portion 22c downward while following the base portion 15 in a state in which the hook portion 22c abuts against the base portion 15.

What is claimed is:

1. A connector with a holder, the connector comprising:
a bottomed tubular housing that includes a holder accommodating portion and that is provided with a terminal protruding into the holder accommodating portion; and
a holder that is inserted into the holder accommodating portion, that is lockable to a wall portion of the holder accommodating portion located on a side opposite to an opening end of the holder accommodating portion, and that includes a base portion formed with a hole through which the terminal is inserted,
wherein the holder includes a rib body portion that protrudes from the base portion toward the opening end of the holder accommodating portion, and a rib reinforcing portion that protrudes from an upper face of the rib body portion and that extends from the base portion to a distal end of the rib body portion,
wherein an insertion hole is formed at a position of the rib body portion that is adjacent to the rib reinforcing portion or at a position of the rib reinforcing portion that is adjacent to the rib body portion, and
wherein a hook portion provided at a distal end portion of a jig is inserted into the insertion hole when the holder is removed from the housing.

2. The connector with a holder according to claim 1,
wherein the insertion hole is formed at a position of the rib body portion that is adjacent to the base portion.
